(19) United States
(12) Patent Application Publication
(10) Pub. No.: US 2008/0140485 A1
(43) Pub. Date: Jun. 12, 2008

(54) Project management and assessment method

(76) Inventor: Theodore R. Williams, Long Valley, NJ (US)

Correspondence Address: HOFFMANN & BARON, LLP, 6900 JERICHO TURNPIKE, SYOSSET, NY, 11791, US

(21) Appl. No.: 12/001,398

(22) Filed: Dec. 11, 2007

Related U.S. Application Data
(60) Provisional application No. 60/874,142, filed on Dec. 11, 2006.

(51) Int. Cl. G06Q 10/00

(52) U.S. Cl. 705/7

(57) ABSTRACT

The present invention relates to a project assessment method and software featuring processes and tools for the implementation and assessment of large, business critical, and high risk business programs and projects. The method provides a work breakdown structure life cycle; a set of work breakdown structure milestones, selected from health check, monthly status, and certification milestones; assessing each milestone based upon process, delivery, and certification process assessment areas; determining best practices; optional feedback mechanisms; and reports at each step to evaluate and provide structured recommendations regarding the status or execution of a project.

### CROSS-REFERENCE TO RELATED APPLICATION

This application claims priority to U.S. Provisional Patent Application No. 60/874,142, filed on Dec. 11, 2006, herein incorporated by reference.

### FIELD OF THE INVENTION

The present invention relates to a project assessment method and software featuring processes and tools for the ongoing assessment of large, business critical, and high risk business programs and projects. The inventive methods are also useful for assessing the design and implementation of large projects in large organizational environments, such as corporations or governmental agencies.

### BACKGROUND

Management and control of projects is an ongoing challenge in business environments. For example, experts estimate that as many as 70% of software projects fail to meet budget or schedule performance commitments, and thus fail to meet one or more expectations of success. Projects in a business environment must meet a variety of goals in order to qualify as successful. Generally, a project will have a budgetary requirement, a timeline for completion, a performance scope and a performance objective.

In order to meet the need for management of projects, various methods and software packages have been developed to aid managers and employees executing projects in a business environment. Software has the inherent advantage of providing automated systems, standardized reports, and the exchange of information that is necessary to successfully execute a complex and critical project. For example, MS Project allows a user to organize and coordinate relatively simple projects, and Artemis (see http://www.aisc.com/) provides similar functionality on a larger, more complex scale. Neither of these tools are intended to perform comprehensive project assessments. Rather, they provide scheduling and resource allocation functions.

Similarly, the “Project Management Institute” (PMI) has a publication and process called “PMBOK,” or “Project Management Body of Knowledge,” that addresses project management. The PMBOK Guide, 3rd ed., provides an internationally recognized standard (IEEE Standard 1490-2003) that provides the fundamentals of project management as they apply to a wide range of projects, including construction, software, engineering, automotive, etc. However, PMBOK does not provide a suite of tools, nor does it provide advice or suggestions for accomplishing goals. The expectation is that project management knowledge, training, and experience will teach a novice project manager how to run an a specific project. Additionally, some practitioners feel that PMBOK is less appropriate for IT (e.g., software development) projects because the underlying principles are based on industrial defined processes.

Another tool related to project management is “Control Objectives for Information and related Technology” (COBIT). This tool provides a set of best practices (i.e., a framework) for information technology management created by the Information Systems Audit and Control Association (ISACA), and the IT Governance Institute (ITGI) in 1992. COBIT provides managers, auditors, and IT users with a set of generally accepted measures, indicators, processes and best practices to assist them in maximizing the benefits derived through the use of information technology and developing appropriate IT governance and control in a company. COBIT is not however, an integrated solution to the challenge of project management. COBIT is a method, and on purchasing COBIT, the user gets books or online access describing the method. Implementation is left to the individual practitioner.

### SUMMARY OF THE INVENTION

Accordingly, this invention provides processes and methods for the management and assessment of large, business critical, or high risk business programs or projects. In one aspect, this invention provides a process for the ongoing measurement and assessment of a business project, employing an integrated computer application that performs the steps of:

(a) providing a work breakdown structure life cycle;

(b) providing a set of work breakdown structure milestones, wherein the milestones are selected from health check, monthly status, and certification milestones;

(c) providing a plurality of levels in an organizational breakdown structure;

(d) gathering project information and requirements;

(e) monitoring milestones;

(f) assessing each milestone based upon ten process, five delivery, and two certification process assessment areas; and

(g) determining best practices;

wherein users are provided with reports at each step to aid in the evaluation and execution of a project.

In an aspect of this embodiment, the computer application provides a feedback loop from the best practices step to the step where the work breakdown structure life cycle is provided.

In some aspects of this embodiment, the work breakdown structure life cycle is a project management life cycle, a systems development life cycle, or an assessment area life cycle.

In other aspects of this embodiment, the reports evaluate the budgetary status, timeliness, and performance of each step of the project. A report may be generated for each milestone, further comprising reports on scope delivery, budgetary status, timeliness, quality, benefit realization, and process performance of said milestone.

In another embodiment, this invention provides a process for the management and assessment of a business project, with an assessment process flow involving the steps of:

(a) identification of the project;

(b) creation of a project database, and populating the database with relevant project information;

(c) selection of a project management life cycle or systems development lifecycle or both, wherein each life cycle contains a plurality of phases;

(d) determining an appropriate milestone for each lifecycle phase selected from:
(i) health check milestones;
(ii) monthly status milestones; and
(iii) performance certification milestones;

(e) distribution of milestone reports;

(f) identification of best practices;

(g) performing a follow-up based on findings and recommendations.

In an aspect of this embodiment, the findings and recommendations may be employed in a feedback loop with the step (d), to adjust milestones based on intermediate outcomes. In some embodiments, the project may be completed after the follow-up based on findings and recommendations.

In another aspect, an integrated computer application is provided for the process for the management and assessment of a business project. The computer application accepts input from project participants, provides a structured view of the project to participants, and generates reports. The computer application may utilize a set of core and supporting components with reference tables for each step and phase of the project, an administration module for project administration, and a reporting module that contains reports.

The computer application may further employ licensed content within the framework of this invention. For example, the WBS life cycle, rating metrics, assessment criteria, and generated reports may all employ content licensed from subject matter experts. Client specific elements may be provided for assignment of assessment elements, establishment of rating metrics, and assessment criteria.

In an aspect of the computer application of this invention, an Earned Value Management process is employed in a computer software application, comprising:

(a) providing pre-defined steps in the project, and comparing actual progress to planned progress at a predefined step;

(b) preparing a report evaluating the status of the project; and

(c) providing automated alerts if pre-determined performance goals are not met.

In another embodiment of this invention, an assessment of a business project providing a structured evaluation and recommendations may be provided, that may involve the steps of:

(a) assigning a Work Breakdown Structure comprising at least one life cycle determined in advance;

(b) providing one or more assessment milestones mapped to the project's project management (PMLC), systems development (SDLC), or assessment area (AALC) life cycle;

(c) providing one or more milestone evaluations, selected from a Health Check, Monthly Status, and Certification milestones;

(d) providing at least one report based on the milestone evaluations; and

(e) means for making structured recommendations based on ratings determined in milestone evaluations.

Still further, another embodiment of this invention provides a method for the assessment of a project, that may employ:

(a) assigning at least one activity or IOTT to be performed;

(b) assigning at least one assessment element to be evaluated;

(c) establishing a set of rating metrics;

(d) providing assessment criteria;

(e) wherein rating rollups are provided with override capability.

A tangible result of the inventive evaluations and assessments are more efficient projects, that require fewer resources to achieve a pre-determined goal; an increased probability that the project's delivery commitments will be met; specific information regarding the need to continue work on the project, or to declare a project complete; or development of best practices for a process.

### BRIEF DESCRIPTION OF THE DRAWINGS

FIG. 1 is the Assessment Process Flow of the Invention. The major steps are shown in order of execution. Note the optional feedback loop to the WBS step.

FIG. 1A shows typical information for steps of the assessment process flow where information is updated.

FIG. 1B shows typical information that is updated in support of the assessment process flow by global and OBS specific administrators.

FIG. 2 is an alternative view of the relationships between the various steps in the method, showing the seven core components and the three supporting components.

FIG. 3A shows the Work Breakdown Structure (WBS) components such as WBS Life Cycles, WBS Phases, WBS Assessment Areas, WBS Activities, and WBS IOTTs (Inputs, Outputs, Tools & Techniques), and is where the content for this method and the content licensed from leading subject matter experts (SMEs) will reside. A WBS Life Cycle will contain either WBS Phases or WBS Assessment Areas, but not both.

FIG. 3B illustrates the Work Breakdown Structure (WBS) for the WBS Milestones. The WBS Milestone shares many of the same components as the WBS Life Cycle. The WBS Milestone, however, can contain WBS Phases, WBS Assessment Areas, or both.

FIG. 4 shows the Organizational Breakdown Structure (OBS). The number of OBS levels, name of the OBS levels, relationship between OBSs, and OBS specific data are provided by the client. The OBS is used to identify Projects (and Milestones), Users (for security and access rights), Stakeholders, and Contacts.

FIG. 5 shows the Project component hierarchy. The components used to maintain project related information which include project data, deliverables, baselines, critical success factors, notes, health check schedule, delivery areas (i.e. scope, schedule, budget, quality, benefits), and final delivery metrics.

FIGS. 6A-C show the Milestone components and hierarchy.

FIG. 6A shows the “Health Check” milestone hierarchy, used to assess the health of a project at predetermined toll gates.

FIG. 6B shows the “Monthly Status” milestone hierarchy, used to assess monthly progress of the project.

FIG. 6C shows the “Certification” milestone hierarchy, used to provide management with certification of the project's delivery commitments and process performance.

FIG. 7A shows the Milestone specific rating hierarchy. Milestone assessments can be performed at the IOTT and/or Activity level and are rolled up to the next level with the capability to be overridden. Rating Elements document the assessment attributes, Rating Metrics reflect the assessment measurement, Rating Criteria provide the basis for the metric selection, and Rating Exceptions indicate the threshold for appearing on an exception report.

FIG. 7B shows the Project specific ratings used in the method. Ratings for scope, quality, and benefit items are rolled up to their respective scope, quality, and benefit delivery areas with the capability to be overridden.

FIG. 8 shows the Best Practice hierarchy. Best Practice (BP) contains the components for leveraging best practices across the organization. BP Lessons Learned are linked to WBS Activities. BP Templates and BP Examples are linked to WBS IOTTs. BP Critical Success Factors are linked to the Project.

FIG. 9 is an illustration of the three life cycles that are part of the WBS. FIG. 9 is a generic representation of these life cycles.

FIG. 10 shows detail on the project management life cycles (PMLCs) and four systems development life cycles (SDLCs).

FIG. 11 shows the assessment area life cycles (AALCs), showing ten process areas, five delivery areas, and two certification process areas.

FIG. 12A shows assessment milestones mapped to the Project Management Life Cycle (PMLC).

FIG. 12B shows assessment milestones mapped to the Systems Development Life Cycle (SDLC).

### DETAILED DESCRIPTION

The present invention provides a method for the ongoing measurement and assessment of large, business critical, or high risk programs or projects in an organizational environment, such as a corporation or large business. The method is not limited, however, to private, for-profit entities, and may be especially valuable in a government program, which commonly are large projects, such as a weapons development program or a highway construction project.

This invention further focuses on the interaction between the “Project Management” and the “Project Assessment” disciplines and features structured processes for management and assessment of projects. In some embodiments, a computer application is provided, such as an integrated web-based application. By “Project Management” is meant the discipline of planning, organizing, and assigning resources to accomplish a goal.

By “Project Assessment” is meant the discipline of rating the effectiveness of a project, as a whole or at an intermediate phase. Several important factors are relevant in any project assessment exercise. To be effective, a project must meet budgetary, scope, and timeline requirements. For example, a project with a planned cost of $1 million, that actually costs $2 million to accomplish its objectives, is not fully successful in meeting its budget. The 100% increase in cost, in this example, can have a substantial negative effect on the return on investment (ROI) of the overall project.

Several tangible results are possible by use of the inventive evaluations and assessments. In one embodiment, this invention results in more efficient projects, that require fewer resources to achieve a pre-determined goal. In another embodiment, this invention provides specific information relating to project that can be used for the evaluation, planning, and decision-making purposes. For example, this invention can provide data, reports, and structured recommendations regarding the need to continue work on the project, or to declare a project complete. In another embodiment, this invention will increase the probability of successfully meeting the project's scope, schedule, budget, quality, and benefit delivery commitments. In another embodiment, this invention can provide for the development of best practices for a process.

By the term “structured recommendations” in the foregoing paragraph, is meant that a specific plan can be developed in advance, and specific courses of action can be pre-determined depending on an outcome. For example, if “A” occurs, then action “B” will be recommended. Thus, if a task is behind schedule or overbudget by a certain amount, a warning can be raised to project managers or senior managers alerting them to the difficulty. The pre-plan may call for a warning at 10% overbudget, a formal letter at 20% overbudget, and so forth. At a critical juncture, the pre-plan can even specify that a project be terminated if a certain goal cannot be achieved. These are all structured recommendations that can provide Senior Management with an opportunity to be more proactive in their decision making regarding the project or its product.

Most industry standards such as PMBOK and COBIT are process based. The method for this invention also addresses the delivery aspect of project performance. The problem with relying on a process based approach for assessments is that the processes may be performing well, but the project is at risk of not meeting its delivery commitments for a number of other reasons, and vice versa. The use of process and delivery perspectives provides a balanced scorecard.

The other major delivery assessment areas are scope, timeline, quality and benefits. By project scope is meant whether the program succeeds in its operational goals. For example, if the project is the development of a database with ten features, but the developers are only able to implement six of those features, the project has not met its scope goals. A timeline example is that the project has a planned completion in a certain period of time, say six months, but it actually takes nine months to construct the product with the planned functionality. Quality examines the quality of the product being developed relative to defects and how well it will meet customer expectations. Benefits represent the justification or business rationale for why the project was undertaken. As with the budgetary problem example, any of these problems can likewise have a negative affect on the ROI of a project. Accordingly, these areas are the focus of substantial scrutiny by organizational managers, in order to plan and execute projects that meet all requirements set forth at the outset of the project development process.

The technique of Earned Value Management (EVM) is utilized to validate the scope, schedule, and budget delivery results. EVM measures the actual work planned and completed. In an EVM exercise, the practitioner sets a valuation, in advance, on a project or a part of a project. As the project or portion thereof is completed, pre-defined earnings rules are employed to evaluate and quantify the work, to arrive at an “earned value.” In an EVM exercise, at pre-defined steps in the project, the actual progress is compared to the planned progress of the project. By tracking the actual progress with the planned progress, an evaluation can be made as to whether the project is proceeding within, and appears to be on track to achieve the technical objectives, timeliness, and costs planned. If the earned value begins to fall below the planned value, this can alert managers to a problem with the project.

Further, in many respects, EVM applies quantitative methods to project management and assessment. As such, it is highly amenable to computerized and automated tools, as more fully described herein.

As with the discussion of PMBOK and COBIT above, EVM is not a complete tool for project management. While EVM methods provide tools to assess the “value” of a project at a point in time prior to completion, or at completion, EVM depends on practitioners to specifically implement the method. Further, the EVM method does not evaluate the quality of the project. Thus, a project can look highly successful from an EVM standpoint, and meet scope, timeliness, and budgetary goals, yet still fail to meet customer expectations.

The term “project” is used very broadly in this disclosure, and is meant to include any organized endeavor that is amenable to the management and assessment methods as disclosed herein. The meaning of “project” herein is not a special meaning, and dictionary meanings apply. Synonyms that are used in this disclosure include “program,” “scheme,” “proposal,” and “plan.” However, the method of this disclosure is generally applicable to large and complex projects, where the stepwise breakdown, organization, and assessment methods of this invention are likely to be of value.

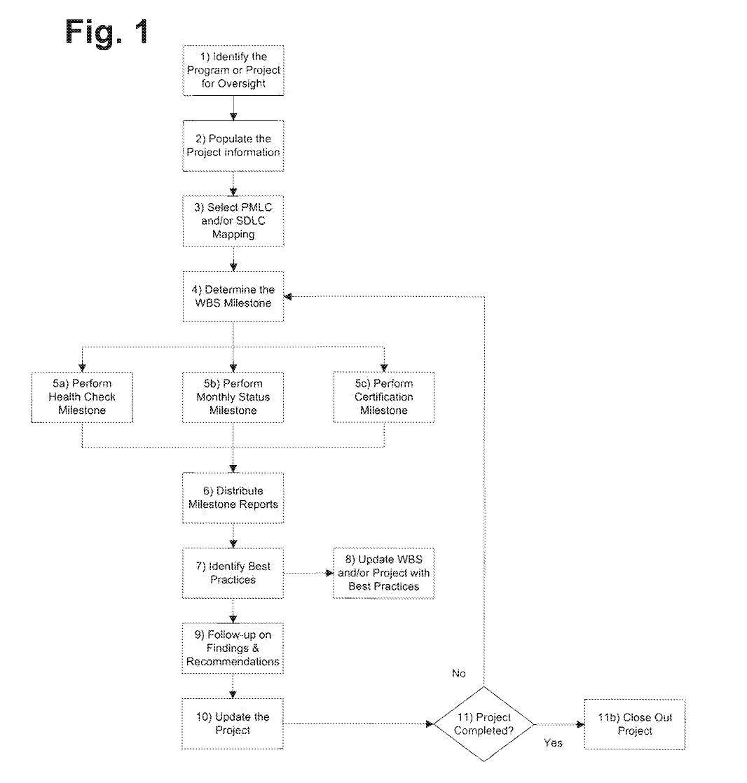

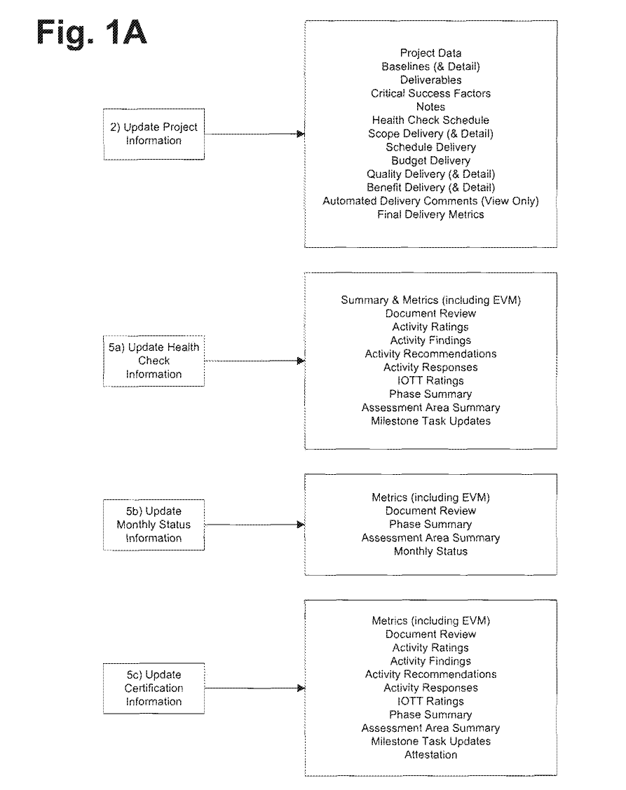

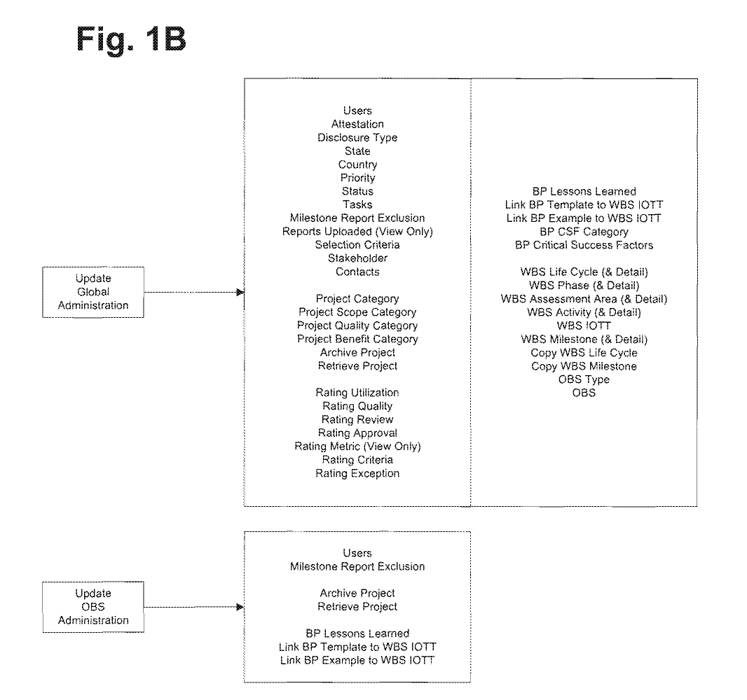

In the broadest sense, the method of this invention provides an assessment project flow, illustrated by the flowchart in FIG. 1. In one aspect, this invention provides a process for the management and assessment of a business project, with an assessment process flow involving the steps of:

(a) identification of the project;

(b) creation of a project database, and populating the database with relevant project information;

(c) selection of a project management life cycle or systems development lifecycle, or both, wherein each life cycle contains a plurality of phases;

(d) determining an appropriate milestone for each lifecycle phase selected from:
(i) health check milestones;
(ii) monthly status milestones; and
(iii) performance certification milestones;

(e) distribution of milestone reports;

(f) identification of best practices;

(g) performing a follow-up based on findings and recommendations.

As a brief overview of this method, the following steps are performed in the inventive process, as illustrated in FIG. 1.
1) Utilizing an established selection criteria, identify the Program(s) and/or Project(s) requiring oversight.
2) Populate the Project (or Program) Information.
3) Select the appropriate Project Management Life Cycle (PMLC) and/or Systems Development Life Cycle (SDLC) mapping. It is generally recommended that only one of the life cycle approaches be utilized unless circumstances require both.
4) Determine the appropriate WBS Milestone to be performed.
5) Perform the Milestone. Milestone checklists, worksheets, and delivery validation reports can be utilized. Ratings will be entered/updated for the project, and for the assessment milestone at the IOTT and/or Activity levels along with findings and recommendations at the Activity level. Earned Value Management (EVM) will be utilized to validate scope, schedule, and budget performance.
   a. Health Check—PMLC or SDLC phase based toll gate reviews.
   b. Monthly Status—ongoing performance feedback.
   c. Certification—periodic certification of results and expectations.
6) Distribute Milestone Reports—prepare the draft report, hold an internal peer review, distribute the draft report, revise the draft report as necessary based upon feedback, prepare and distribute the final report.
7) Document Best Practices identified during the Assessment Milestone. These will include Lessons Learned, Templates, Examples, and Critical Success Factors.
8) Update the WBS Activities with Best Practice Lessons Learned, the WBS IOTTs with Best Practice Templates and/or Examples, and the Project with Best Practice Critical Success Factors.
9) Follow-up on Findings & Recommendations from the Milestone.
10) Update the Project with current information.
11) Evaluating if the project is completed:
   a. If no, go to determine next milestone;
   b. If yes, close out project.

FIG. 1A shows in more detail some typical information that may be employed at each step of the Assessment Process Flow as shown in FIG. 1.

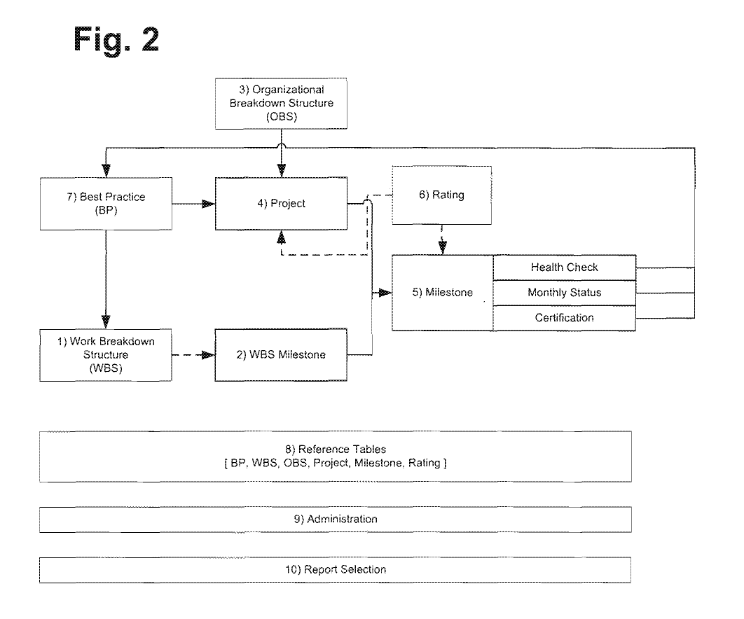

The inventive method has a set of seven core components and three supporting components, illustrated in FIG. 2. The core components are:

1) WBS—used to maintain the WBS Life Cycles (i.e. Content)

2) WBS Milestone—used to maintain the WBS Milestones

3) OBS—contains the client's organization structure

4) Project—used to maintain information related to the Project or Program receiving oversight

5) Milestones—used in performing the Assessment Milestones

6) Rating—used to maintain the assessment methodology

7) Best Practice—used to document and maintain Best Practices

The supporting components are:

8) Reference Tables—used to maintain the tables supporting the Best Practice, Work Breakdown Structure, Organizational Breakdown Structure, Milestone, and Rating components

9) Administration—used for overall product administration

10) Report Selection—used to maintain available reports

An important feature of FIG. 2 is the convergence of processes at the Milestone component. Thus, the Organizational Breakdown Structure and Project components, which are organizational and information gathering functions, lead to the Milestone component, and the WBS components, which are more operational and functional in nature, likewise lead into the Milestone component. Similarly, the Rating component leads to the Milestone and Project components. This convergence illustrates the critical importance in the inventive method of the assessments and evaluations that occur within the Milestone component.

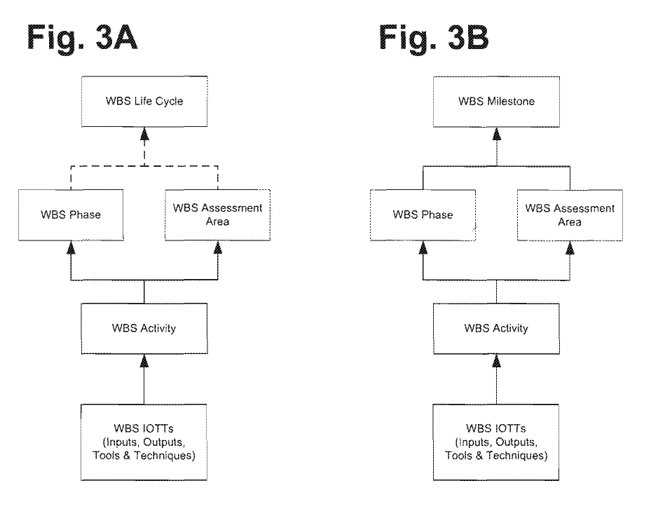

With respect to the core components, the initial component is the Work Breakdown Structure (WBS). This is illustrated in FIG. 3A. The WBS may contain components such as WBS Life Cycles, WBS Phases, WBS Assessment Areas, WBS Activities, and WBS IOTTs (Inputs, Outputs, Tools & Techniques). The WBS Life Cycle may include content licensed from third parties, or from leading subject matter experts (SMEs).

Typical content that is compatible with the inventive method includes:
PMBOK
COBIT
Six Sigma
Integrated Baseline Review (IBR)
Capability Maturity Model (CMM)
third party tools to ensure compliance with Sarbanes-Oxley (SOX) rules.

A WBS Life Cycle may contain either WBS Phases or WBS Assessment Areas, but not both. WBS Phases and WBS Assessment Areas will contain WBS Activities.

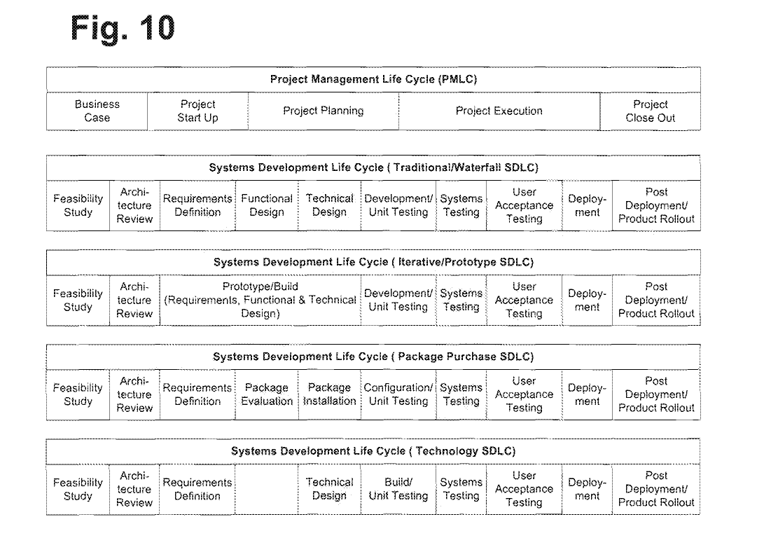

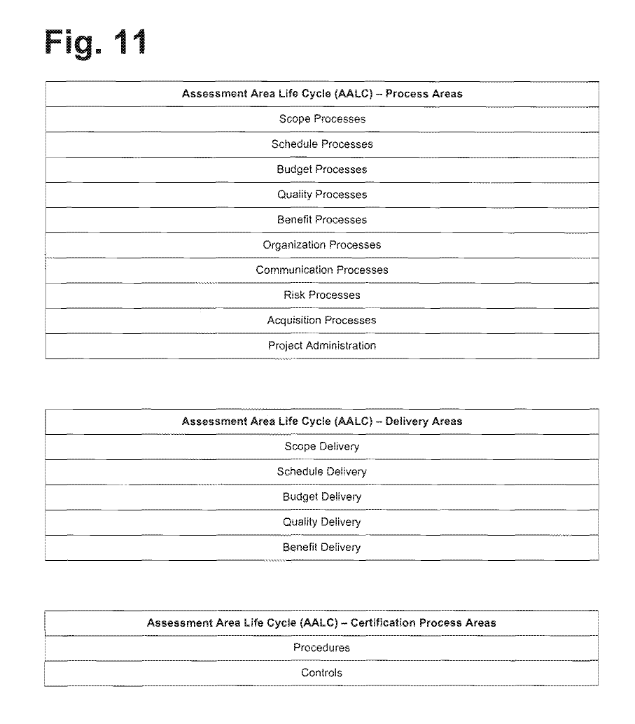

A “WBS Activity” is any task performed in a WBS stage, and may be process or delivery based. For example, any specific element within a life cycle (see FIG. 10 or 11), such as an architecture review for a machine, is an “activity” within this meaning. A process-type activity may be something like developing a method of performing a task, such as the design of a series of similar components that only require minor variations. A delivery-type activity may be to actually deliver a physical part to a customer.

WBS IOTTs are the corresponding inputs, outputs, and tools and techniques for the WBS Activities. Inputs are items that feed the activities. Outputs are items that are produced by the activities. Tools and Techniques are items that facilitate the activities. For example, for the activity “Develop the Business Case”, an input would be the original Work Request, an output would be the Business Case Report, and a tool and technique would be a Business Case Template or a Financial Review.

The next core component is the WBS Milestone component. This is illustrated in FIG. 3B. This component may contain the Work Breakdown Structure (WBS) for WBS Milestones which are created based upon the corresponding WBS Life Cycles, WBS Phases, WBS Assessment Areas, WBS Activities, and/or WBS IOTTs (Inputs, Outputs, Tools & Techniques). A WBS Milestone can contain either WBS Phases or WBS Assessment Areas, or both.

WBS Life Cycles and WBS Milestones are created and maintained based upon the following hierarchical rules:
WBS Life Cycles may contain either WBS Phases or WBS Assessment Areas, but not both
WBS Milestones may be created based upon WBS Life Cycles, and can consist of WBS Phases, WBS Assessment Areas, or both
WBS Phases may contain of WBS Activities and are categorized by WBS Phase Type
WBS Assessment Areas may contain of WBS Activities and are categorized by WBS Assessment Type and WBS Assessment Group
WBS Activities may include of WBS IOTTs (Inputs, Outputs, and Tools & Techniques) and are either Process or Delivery based
WBS Activities may be linked to Best Practice (BP) Lessons Learned
WBS IOTTs may be linked to Best Practice (BP) Templates and/or Examples
Milestone Ratings can be applied at the WBS IOTT and/or WBS Activity levels

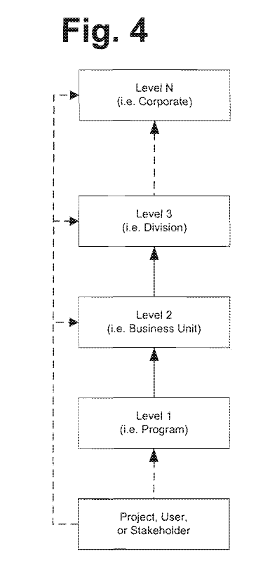

The next core component is the Organizational Breakdown Structure (OBS), illustrated in FIG. 4. The OBS pertains to the organizational hierarchy involved in the project. The number of OBS levels, name of the OBS levels, relationship between OBSs, and OBS specific data are provided by the client, and are specific to the client's organizational structure. The OBS is used to identify Projects (and Milestones), Users (for security and access rights), Stakeholders, and Contacts. For example, an initial project approval is likely to involve higher levels of management. Operational tasks are more likely to involve lower levels, populated by technical contributors.

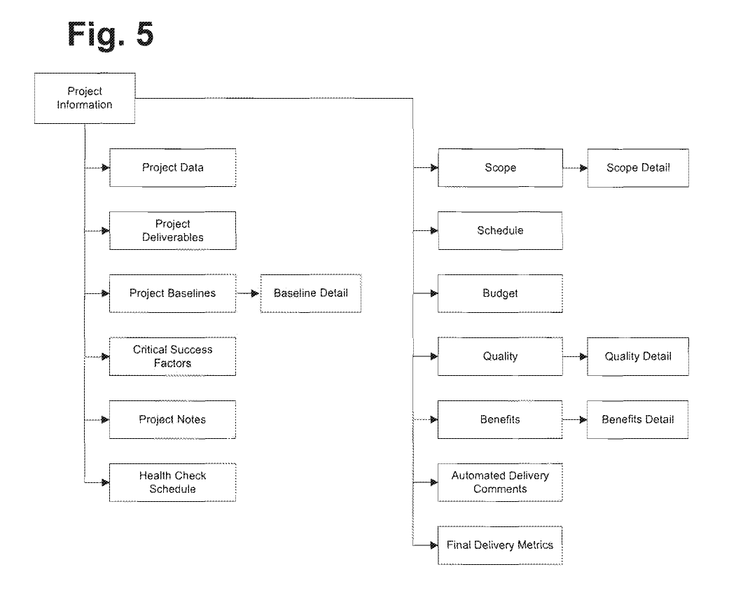

The next core component from FIG. 2 is the Project component, illustrated in FIG. 5. The Project component may contain various sub-parts used to maintain project related information which include project data, deliverables, baselines, critical success factors, notes, health check schedule, delivery areas (i.e. scope, schedule, budget, quality, benefits), and final delivery metrics.

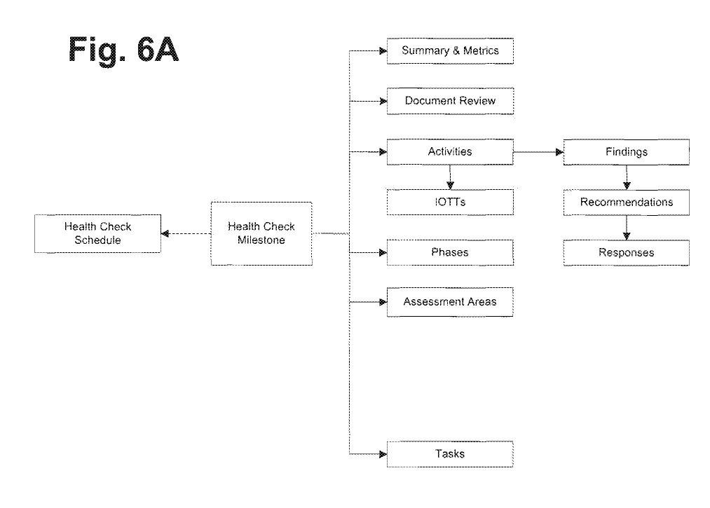

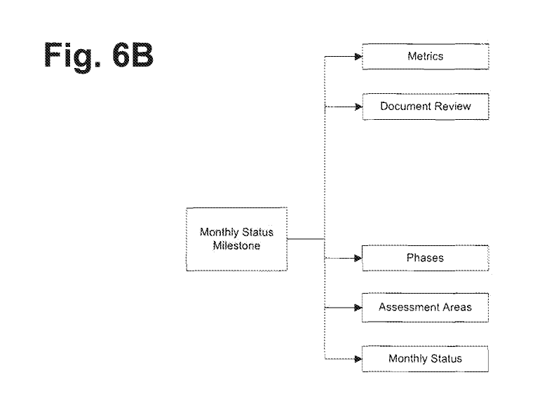

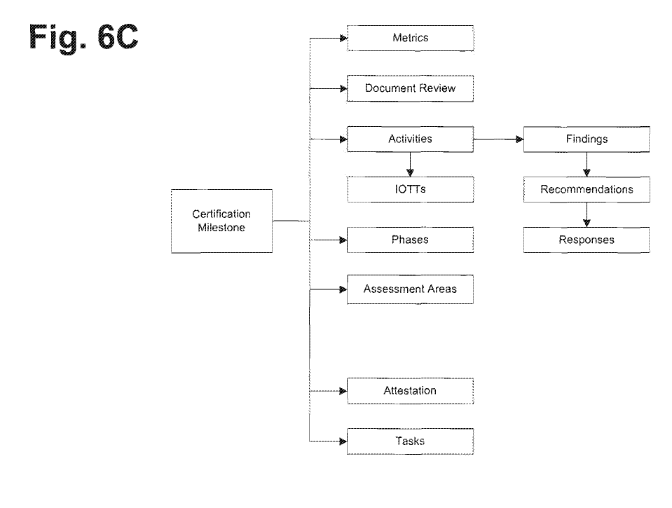

The next core component in FIG. 2 is the Milestone component, illustrated in FIGS. 6A-C. The Milestone component typically contains the sub-parts used to create and maintain Milestones. The inventive method features at least three milestone types, Health Check, Monthly Status, and Certification. Each type contains the corresponding milestone components. A Milestone is created based upon a specific WBS Milestone and Project.

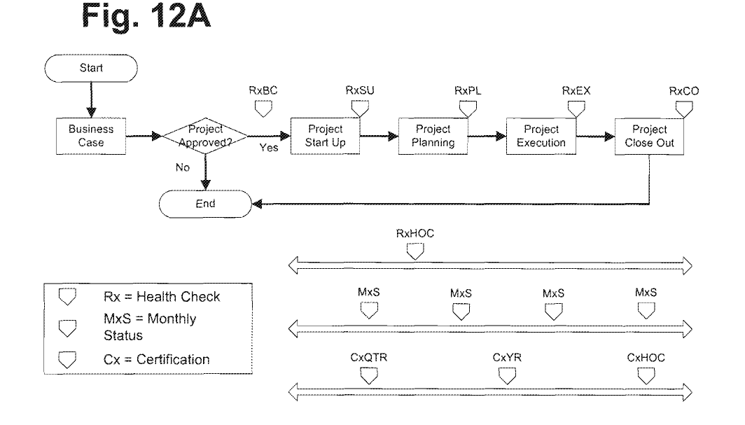

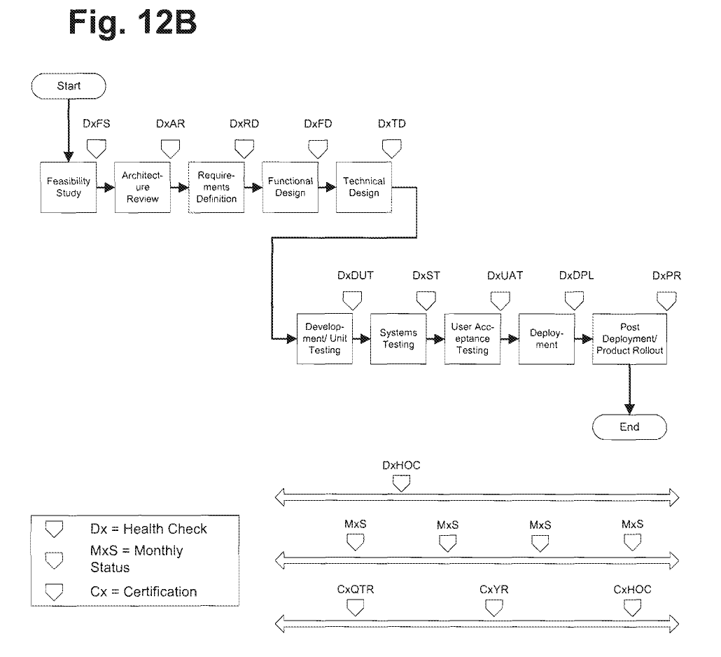

Health Check Milestones (FIG. 6A) are used to assess the health of a project at predetermined toll gates. Put differently, as a project is broken down into smaller sub-parts, each of which has a set of objectives, the Health Check Milestones will be evaluated as each component part is completed, to ascertain the quality of the sub-part. This general concept is shown graphically in FIG. 12, where the Health Check Milestone is evaluated as each component part is completed.

Monthly Status Milestones (FIG. 6B) are used to record the monthly progress of a project. This is a parallel milestone component to the Health Check Milestones, but the Monthly Status Milestone is performed at a regular time interval, typically on a monthly basis. For example, a Monthly Status Milestone may be reviewed on first business day of the month.

The Certification Milestones (FIG. 6C) are used to provide management with certification of the project's delivery commitments and process performance. Typically, this will involve reports to senior management or other stakeholders, for example, it may include financial analysts or venture capitalists. The certification milestones would be used to ensure these stakeholders that the project is on track. Additionally, the milestone may be used to discuss remedial measures of a problem or delay has occurred.

Note that insofar as milestones, as described above, are an assessment process in the project in the inventive method, additionally special milestones can be envisioned by those skilled in the art. Thus, the terms “Health Check,” “Monthly Status,” or “Certification” milestones are not meant to be limiting. Depending on the nature of the project, additional milestone types may be employed in practice. For example, a project may require weekly status milestones, where a milestone evaluation is performed on a weekly basis.

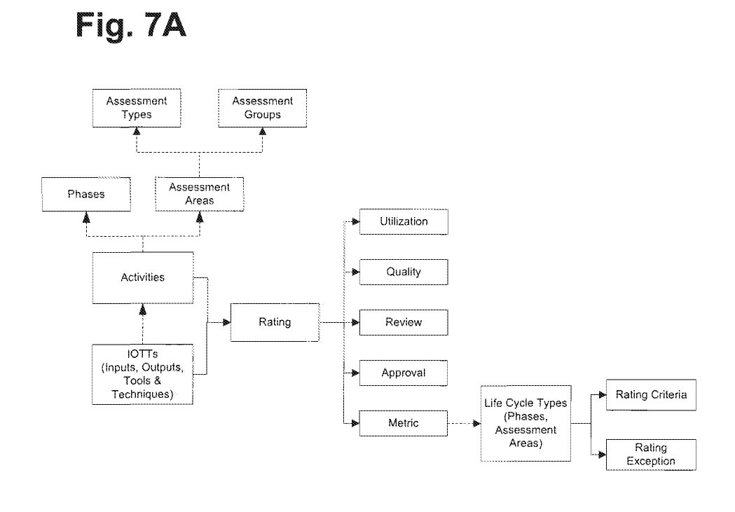

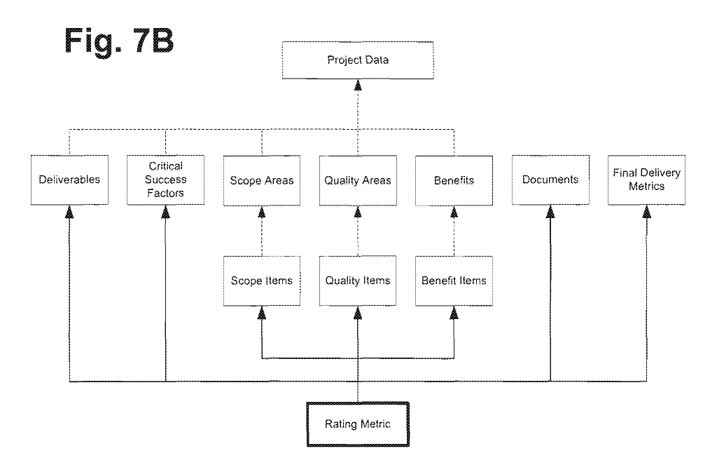

The next core component in FIG. 2 is the Ratings Component, shown in FIG. 7A. The Rating component contains the flexible assessment methodology used for projects and milestones. Milestone ratings can be performed at the IOTT or Activity Level (or both) and are rolled up to the next level with the capability to be overridden. Rating Elements document the assessment attributes, Rating Metrics reflect the assessment measurement, Rating Criteria provide the basis for the metric selection, and Rating Exceptions indicate the threshold for appearing on an exception report.

Ratings are provided for the Project as shown in FIG. 7B. Ratings for scope, quality, and benefit items are rolled up to their respective scope, quality, and benefit delivery areas with the capability to be overridden.

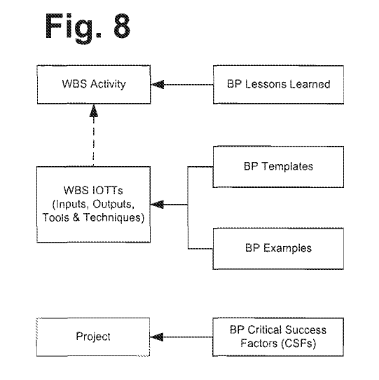

The final core component is the Best Practice component, shown in FIG. 8. Best Practice (BP) contains the components for leveraging best practices across the organization. BP Lessons Learned are linked to WBS Activities. BP Templates and BP Examples are linked to WBS IOTTs. BP Critical Success Factors are linked to the Project.

As shown in FIG. 1 and the accompanying discussion, in the first step of the inventive method, a project is identified using pre-determined criteria. Secondly, important delivery parameters are identified, including scope of the project, budget, delivery timeframe, quality, and benefits. By the term “scope” is meant the operational goals of the project, or put differently, what the final product should do. If the project is not product oriented, the scope could be a functional outcome of the project. For example, if the project is the design and construction of computer printer, the scope might include the expected quality of the printing, the speed of pages that are ejected, the ability to print special graphics. The second step, therefore, is a plan with one or more of the following elements:
Deliverables
Critical success factors
Health check schedule
Scope delivery and detail
Schedule delivery
Budget delivery
Quality delivery and detail
Benefit delivery and detail
Final delivery metrics.

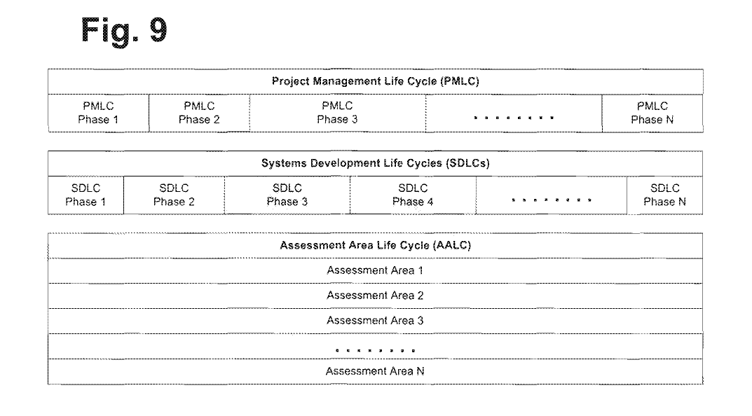

Step 3 of this method is the selection of a lifecycle, which may be selected from a “Project Management Life Cycle,” a “Systems Development Life Cycle,” and an “Assessment Area Life Cycle.” See FIGS. 9-10. The different life cycles perform different purposes. The Project Management Life Cycle addresses how a project is managed. The Systems Development Life Cycle addresses how a project is developed. The Assessment Area Life Cycle addresses how a project, and any product resulting therefrom, will be assessed and evaluated. The three Life Cycles exist in parallel to each other, and while they are related, they are not formally linked to each other as Life Cycles. However, it is possible to formally link PMLC phases, SDLC phases, and/or Assessment Areas as WBS Milestones. Note that these life cycles are not a limiting list. Additional life cycle methodologies can be envisioned for this invention. Additionally, the specific steps that are discussed in the life cycles illustrated in FIG. 10 may be deleted, additional steps may be necessary. Note additionally that the various steps in FIG. 10 are fairly generic, and practitioners must fill in necessary operational details to perform a given step.

The SDLC Life Cycles consist of four individual life cycles that are based on how the product is developed (i.e. utilizing a traditional/waterfall, iterative/prototype, package purchase, or technology development approach). See FIG. 10. The Assessment Areas are illustrated in a horizontal format because they may be related to multiple PMLC or SDLC phases.

One PMLC is included in the inventive method, as shown in FIG. 10. There are phases for a Business Case, for Project Startup, for Project Planning, Project Execution, and Project Close Out.

Four SDLCs, with fifteen individual phases, are included in inventive method, as shown in FIG. 10. In the Traditional/Waterfall SDLC, all phases occur serially. In the Iterative/Prototyping SDLC, the requirements and design are performed as iterative builds based on the result of joint application development sessions facilitated between the developers and users. The Package Purchase SDLC pertains to the purchase of an application from a third party. The Technology SDLC is used for technology or infrastructure development.

The Assessment Area Life Cycle, as disclosed in FIG. 11, contains ten process areas, five delivery areas, and two certification process areas. The Assessment Area Life Cycle is used to define logical assessment categories relative to the PMLCs or SDLCs. Assessment Areas are also categorized by Type and Group.

Within the types of assessment areas, the process area addresses how well the processes support delivery commitments. The delivery areas address whether delivery commitments will be met. There are three Assessment Area Groups: Project Management, assessing how the project is managed; Systems Development; addressing how the product is developed; and Quality Management; addressing the quality of the product and how well it meets customer expectations. Assessment Type and Group allow for the Assessment Areas to be summarized and analyzed based upon different perspectives such that secondary trends can be identified.

The Milestones are shown in additional detail in FIGS. 12A and 12B. The inventive Framework utilizes a three-prong assessment milestone process consisting of the following milestone types:
Health Check—toll gate reviews mapped to the PMLC or SDLC. Milestone outcomes include 1) a backward review of the completed phase to ensure that all activities were successfully completed, 2) a Go/No Go decision to proceed, and 3) a forward review of the next phase to set the expectations for the next phase review. Reviews are performed at the end of the phase with the exception of Project Execution which is performed after an appropriate period of time (i.e. 2 to 3 months) has passed to determine how the processes are performing. If significant issues are present, a follow-up Execution review can be scheduled to ensure that the issues are resolved. Otherwise, the Monthly Status and Certification reviews are used going forward. An Ad Hoc Milestone is available for reviewing specific phases and/or assessment areas where there may be issues. Health Check reviews are usually focused on the delivery and process areas.
Monthly Status—ongoing performance feedback, performed on a regular and pre-determined schedule. These reviews are intended to provide project stakeholders with regular ongoing feedback, and are usually focused on the delivery areas and any process areas requiring attention.
Certification—periodic certification of results and expectations. These reviews are held to validate results and expectations, and are usually focused on the delivery and process areas. An Ad Hoc Milestone is available for reviewing specific phases and/or assessment areas where there may be issues. The actual certification (i.e. Attestation) can be formal or informal.

The Assessment Milestones are mapped to a PMLC as shown in FIG. 12A. Thus, there are Health Check Milestones for evaluating the business case (RxBC), the project start up phase (RxSU), and so forth as shown in FIG. 12A. As shown in FIG. 12A, each Health Check Milestone usually follows the completion of a phase of the Life Cycle. Similarly, Monthly Status Milestones (shown as MxS) are performed at regular monthly intervals. Also shown are Certification Milestones that are also periodic, but less frequent than Monthly Status Milestones. As shown, Certification Milestones might be quarterly, symbolized by the CxQTR Milestone, yearly, symbolized by the CxYR Milestone, or on an ad hoc basis, symbolized by the CxHOC milestone. Similarly, Health Check milestones may be performed on an ad hoc basis, and not necessarily tied to the completion of a phase, as shown by the RxHOC symbol in FIG. 12A.

In FIG. 12A, note that the RxBC Milestone does not directly follow the Business Case phase, but rather follows the approval step. That is because if the project is not approved, the RxBC milestone would not be required. Additionally, note that the RxEX Milestone is depicted during, rather than following, the execution phase. This is because the RxEX would be performed after a period of time has passed during the Execution phase (i.e. 2-3 months) to verify that the Execution processes are working properly. Waiting until the end of the Execution phase would not be meaningful because the purpose is to identify and correct any problems proactively. If there are significant issues identified during the RxEX, a followup RxEX can be scheduled focusing on the resolution of these issues. Otherwise, if a Go decision is given, the Monthly Status milestone (delivery focus) and the Certification milestone are used to provide subsequent assessment information.

Assessment Milestones are mapped to the Systems Development Life Cycle (PMLC) as shown in FIG. 12B. Only the Traditional/Waterfall SDLC is shown, but the same principles would apply to any of the other SDLCs as discussed in FIG. 10. Thus, Health Check Milestones are illustrated at the completion of each phase. For example, DxFS is the Health Check Milestone for the Feasibility Study, and DxDUT is the Health Check Milestone for the Development/Unit Testing phase. Additionally, as in FIG. 12A, there is an ad hoc Health Check Milestone on the lower timeline, shown as DxHOC. Also shown are Monthly Status Milestones (MxS) at regular intervals, and Certification Milestones.

Once the Assessment Milestone is selected and scheduled, the appropriate review is performed in accordance with the inventive assessment methods. In one embodiment of this invention, the assessments are used to make structured recommendations regarding the status of a project. These structured recommendations will provide Senior Management with the opportunity to make decisions about the project or its product that are more proactive and less reactive in nature. These decisions can have significant impact on the direction that the project takes, the product that the project delivers, or the amount of resources that will be required for completion or early conclusion.

This invention utilizes a flexible data model to maintain the hierarchal Work Breakdown Structures (WBSs) and Organizational Breakdown Structures (OBSs).

WBS Life Cycles will consist of 1) WBS Phases or WBS Assessment Areas, 2) WBS Activities, and 3) WBS IOTTs (Inputs, Outputs, Tools & Techniques) as defined within the inventive Assessment Methods.

WBS Milestones will consist of 1) WBS Phases and/or WBS Assessment Areas, 2) WBS Activities, and 3) WBS IOTTs (Inputs, Outputs, Tools & Techniques) as defined within the inventive Assessment Methods.

In addition to the content of various phases and components in the method of this invention, the data model will support the inclusion of content licensed from leading subject matter experts in the areas of project management, quality management, and IT audit, and support the use of other methodologies such as Sarbanes-Oxley (SOX), Integrated Baseline Review (IBR), Six Sigma, Capability Maturity Model (CMM) as well as Client-specific content.

### Software

While an embodiment of this invention as a software application is not mandatory, a software application that manages the inventive method may be desirable. For example, the inventive method could merely be a guide book or a course taught by trained instructors. However, in its richest embodiment, the present invention will be a software application. The software embodiment is shown in FIG. 2 with regard to the seven core and three supporting components.

The software application can be either an installed application, or a web-based application. As an installed application, the application could be written with a tool such as “Microsoft® Visual Studio®.” As a web-based application, the application can be developed with a tool such as PHP or “ASP.NET®.” As envisioned, a software application implementing this invention would also be based on a database, such as Microsoft® SQL Server® or MySQL®.

The entire structure of the inventive method can be implemented into a software application that would store the required data and provide collaborative tools for the method. A software application can provide structured reports and reminders. The reports can be structured so that report writers need not be creative in the design and content of the reports. A structured report might be a form in a software application, with fields for all required or optional items that would appear in the report, that a user with authority would fill in.

For example, in a report on a Health Check Milestone, each feature of the phase just completed would be listed, and whether the feature met is objectives, was delivered on time and in budget, and any other relevant information that would be determined in advance. Report Wizards will be utilized within the application to translate Delivery, Earned Value Management (EVM), Project, and Milestone data into “English-like” text to make the information more “user-friendly”.

The list of content from Subject Matter Experts (SME's), such as PMBOK, COBIT, etc., is particularly amenable to incorporation into a software application. Particularly in the case of a tool such as PMBOK, which comprises a method but leaves implementation to the practitioner, the inventive method provides implementation tools through the software application and structured components in the software.

As noted above, “Earned Value Management” (EVM) is highly amenable to computerized methods because of the quantitative aspects to EVM. Accordingly, the tools and methods of the instant invention can be applied to EVM methods.

Additionally, a software application can provide “wizards,” that is, structured components that ask for specific input and provide structured reports for a predetermined subject area. A wizard is a tool that is programmed in advance, and typically provides dialog windows with instructions, input fields such as lists and boxes for input of text. Further, a wizard typically provides some kind of processing and an output, such as a report. In the inventive method, wizards are provided for automated delivery components, EVM, project data, and milestone data.

In one embodiment of this invention, a software application will be used to make structured recommendations regarding the status of a project. In this embodiment, data will be entered and reports will be produced with structured recommendations based on pre-determined criteria. Some recommendations that the inventive system may make include: reports on the status of the project to project participants and senior managers; reports on best practices; or decisions to initiate a project, or to terminate a project.

In the simplest sense, these structured recommendations take the form of “if A, then B,” where A is an input and B is a recommendation. In actual practice, the structured recommendations will likely be more complex, and take into consideration a plurality of inputs in order to make meaningful recommendations. By employing the inventive methods of Work Breakdown Structures, WBS Milestones, milestone determinations, and formal ratings, the inventive system can substantially improve project assessments and control over prior art project management techniques. An additional software component in the inventive software are the supporting components illustrated in FIG. 2. The reference tables are essentially data repositories for various inputs for the core components. In a typical embodiment, these would be database tables in a SQL database system. The report selection component contains various reports used in the inventive method. The reports may be simple status reports, or more complex reports providing structured recommendations, as discussed above. Further, software wizards may be employed in the input and output of reports. The administration component administers the inventive method from a global or organization specific level.

1. A process for the measurement and assessment of a business project, comprising an integrated computer application that performs the steps of:
(a) providing a work breakdown structure life cycle;
(b) providing a set of work breakdown structure milestones, wherein the milestones are selected from health check, monthly status, and certification milestones;
(c) providing a plurality of levels in an organizational breakdown structure;
(d) gathering project information and requirements;
(e) monitoring milestones;
(f) assessing each milestone based upon ten process, five delivery, and two certification process assessment areas; and
(g) determining best practices;
wherein users are provided with reports at each step to aid in the evaluation and execution of a project.

2. The process of claim 1, wherein a feedback loop provides information from best practices to creating a work breakdown structure life cycle.

3. The process of claim 1, wherein the work breakdown structure life cycle is a project management life cycle, a systems development life cycle, or an assessment area life cycle.

4. The process of claim 1, wherein the reports evaluate the budgetary status, timeliness, and performance of each step of the project.

5. The process of claim 1, wherein a report is generated for each milestone, further comprising reports on scope delivery, budgetary status, timeliness, quality, benefit realization, and process performance of said milestone.

6. A process for the management and assessment of a business project, comprising an assessment process flow comprising the steps of:
(a) identification of the project;
(b) creation of a project database, and populating the database with relevant project information;
(c) selection of a life cycle selected from a Project Management Life Cycle, a Systems Development Life Cycle, and an Assessment Area Life Cycle, wherein each life cycle contains a plurality of phases;
(d) determining an appropriate milestone for each lifecycle phase selected from:
(i) health check milestones;
(ii) monthly status milestones; and
(iii) performance certification milestones;
(e) distribution of milestone reports;
(f) identification of best practices;
(g) performing a follow-up based on findings and recommendations.

7. The process of claim 6, wherein the findings and recommendations are employed in a feedback loop with step (d).

8. The process of claim 6, wherein the project is completed following step (g).

9. The process of claim 6, wherein the process for the management and assessment of a business project, comprises an integrated computer application that accepts input from project participants, provides a structured view of the project to participants, and generates reports.

10. The computer application of claim 9, further comprising a set of core and supporting components with reference tables for each step and phase of the project, an administration module for project administration, and a reporting module that contains reports.

11. The computer application of claim 6, wherein the WBS life cycle, rating metrics, assessment criteria, and generated reports comprise content licensed from subject matter experts.

12. The method of claim 11, wherein client specific elements are provided for assignment of assessment elements, establishment of rating metrics, and assessment criteria.

13. The method of claim 9, wherein an Earned Value Management process is employed in a computer software application, comprising:
(a) providing pre-defined steps in the project, and comparing actual progress to planned progress at a predefined step;
(b) preparing a report evaluating the status of the project; and
(c) providing automated alerts if pre-determined performance goals are not met.

14. An assessment of a business project providing a structured evaluation and recommendations, comprising:
(a) assigning a Work Breakdown Structure comprising at least one life cycle determined in advance;
(b) providing one or more assessment milestones mapped to the project's project management (PMLC), systems development (SDLC), or assessment area (AALC) life cycle;
(c) providing one or more milestone evaluations, selected from a Health Check, Monthly Status, and Certification milestones;
(d) providing at least one report based on the milestone evaluations; and
(e) means for making structured recommendations based on ratings determined in milestone evaluations.
